(19) United States
(12) Patent Application Publication
(10) Pub. No.: US 2006/0081112 A1
(43) Pub. Date: Apr. 20, 2006

(54) Device(s) for and method(s) of adapting and retaining straps

(76) Inventor: Howard Keith Gipson, Trinidad, CO (US)

Correspondence Address: Howard Keith Gipson, 31989 Hwy 12, Trinidad, CO, 81082, US

(21) Appl. No.: 11/250,929

(22) Filed: Oct. 14, 2005

Related U.S. Application Data
(60) Provisional application No. 60/619,599, filed on Oct. 18, 2004.

(51) Int. Cl. G10G 5/00

(52) U.S. Cl. 84/327

(57) ABSTRACT

An adapting device for attaching a strap, with an aperture, loop, ring or similar opening at or near the end, to a combination end pin/electrical output jack or other attachment point on the object, and a retaining device to secure the strap and adapting device thereon. The adapting device being of a flexible, semi-flexible, semi-rigid or rigid material folded (or formed) over upon itself with apertures of suitable size to fit over the combination end pin/electrical output jack or other attachment point. The adapting device is secured through the aperture, loop, ring or other opening at or near the end of the strap. The retaining device being a flat, flexible, semi-flexible, or semi-rigid material with a slotted opening suitable to engage the combination end pin/electrical output jack or other attachment point on the object with the adapting device or a properly fitting strap situated and held between the object and the retaining device.

### CROSS REFERENCE TO RELATED APPLICATIONS

Provisional patent application U.S. 60/619,599

### BACKGROUND OF INVENTION

1. Field of the Invention

This invention relates to adapting and retaining devices and methods for attaching straps to various objects. The invention particularly relates to, but is in no way limited to, the attachment of straps to guitars equipped with a combination end pin/electrical output jack as is common on instruments equipped with various amplification pickup devices and to other similar instruments so equipped.

2. Description of Prior Art

In attaching straps to objects, particularly a guitar strap to a guitar equipped with a combination end pin/electrical output jack as is common on instruments equipped with various amplification pickup devices or other so equipped musical instrument, it is often a problem that the strap does not properly fit the combination end pin/electrical output jack or other attachment point and becomes loosened or detached from the object to which it was attached. In the case of a guitar, or other similar musical instrument, when the strap attachment fails, the guitar (or similar instrument) is liable to fall and become damaged.

Presently there are several means available (I.E. U.S. Pat. No. 4,028,981 U.S. Pat. No. 4,188,851 U.S. Pat. No. 4,357,063 U.S. Pat. No. 4,843,943 U.S. Pat. No. 5,880,384 U.S. Pat. No. 6,080,922 and U.S. Pat. No. 6,259,009B1) for retaining a strap on a guitar, or similar instrument, but none of these address the need to adapt the strap to properly fit the attachment point and be retained thereon, especially in the case of instruments equipped with a combination end pin/electrical output jack as is common on instruments equipped with various amplification pickup devices.

### BRIEF SUMMARY OF THE INVENTION

In the present invention it is recognized that it is desirable to provide a device and method to adapt the strap to properly fit a combination end pin/electrical output jack, or other attachment point and also to provide a method to securely retain the strap to the object. It is also recognized that such devices and methods should be simple, durable, reliable, easy to use, and relatively inexpensive.

The present invention provides a simple and effective means of adapting and retaining a strap on various objects in general and for shoulder straps detachably connected to guitars and similar instruments in particular, especially in the case of instruments equipped with a combination end pin/electrical output jack. The present invention further provides a means of adapting and retaining straps that is inexpensive, simple in its use, reliable and durable.

Various other features of the devices and methods embodied in the present invention will be come obvious to those skilled in the art upon reading the disclosure and inspecting the drawings contained herein.

More particularly, the present invention provides a strap adapter comprised of a thin piece of flexible, semi-flexible, semi-rigid, or rigid material with an aperture in each end and which when folded over upon itself forms a loop that can be attached through an aperture, loop, ring, or similar opening at or near the end of the strap. The apertures in the adapter align to closely fit over the attachment point on the object. The retainer portion of the present invention is comprised of a flat piece of flexible, semi-flexible, or semi-rigid material with a slotted opening suitable to engage a reduced shaft, groove, or other point on the combination end pin/electrical output jack, or other attachment point on the object. The retainer engages the combination end pin/electrical output jack, or other attachment point in such a way that the adapter with strap attached is securely held between the retainer and the object to which the strap is attached.

It is to be understood that the description and examples of the present invention provided herein are not by way of limitation and various modifications within the scope of the present invention will occur to those skilled in the art upon reading these disclosures.

### BRIEF DESCRIPTION OF THE SEVERAL VIEWS OF THE DRAWINGS

FIG. 1 is a perspective view of representative strap adapting and retaining devices of the present invention utilized with the shoulder strap of a guitar. The guitar being equipped with a commercially available combination end pin/electrical output jack type of end pin strap attachment as is common on instruments equipped with various amplification pickup devices;

FIG. 2 is a cutaway view of strap adapting and retaining devices shown in FIG. 1, it is noted that the internal parts of the combination end pin/electrical output jack are not illustrated; and

FIG. 3 is a perspective view of a representative strap adapting device of the present invention made of flexible material in its flat position; and

FIG. 4 is a perspective view of a representative strap adapting device of the present invention made of flexible material in its folded position; and

FIG. 5 is a perspective view of a representative retaining device of the present invention; and

FIGS. 6 and 7 are perspective views of two of several possible methods of attaching the strap adapting device to the strap.

### DETAILED DESCRIPTION OF THE INVENTION

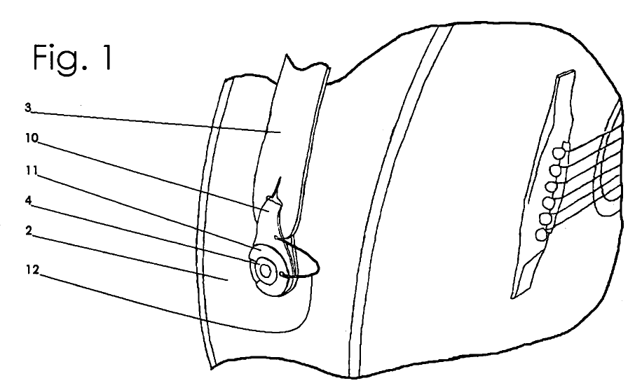

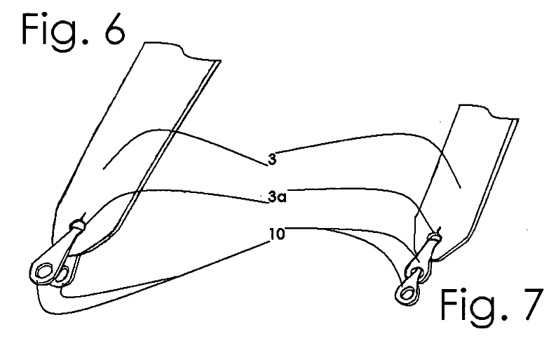

The strap adapter 10 of FIG. 1 is made of a thin piece of flexible, semi-flexible, semi-rigid, or rigid material. It may also be fabricated of multiple pieces of the previously mentioned materials individually or in combination. It is provided with apertures 10a, in either end, of suitable size to fit the combination end pin/electrical output jack, or other attachment point on the object. The strap adapter may also be provided with an aperture 10b so that the retaining device may be attached with a string, cord, or other suitable flexible connector 12 so as not to become separated. The outside shape and size of the strap adapter is limited only by the requirement of a specific application or by convenience. In use one end of the strap adapter is inserted through the aperture, loop, ring or other opening 3a provided at or near the end of the strap 3 and positioned so that the apertures in the strap adapter are in alignment FIG. 6. Alternately one end of the strap adapter is inserted first through the aperture in the strap and then through the aperture in the opposite end of the strap adapter FIG. 7. The apertures in the strap adapter (or aperture as in FIG. 7) are then positioned over the combination end pin/electrical output jack or other attachment point on the object.

The strap retaining device 11 of FIG. 1 is provided to secure the attachment of the strap and strap adapter to the combination end pin/electrical output jack or other attachment point of the object. The strap retaining device is made of a flat piece of flexible, semi-flexible, or semi-rigid material of a suitable size and thickness to engage the attachment point. The retaining device is provided with an opening 11a that is sized to fit a groove, neck, or other reduction in size of the body of the combination end pin/electrical output jack or other attachment point. The retaining device is further provided with an opening or slot 11b. This slot is to be made such that at the outside it will easily engage the combination end pin/electrical output jack or other attachment point and the inside where the slot 11b meets the opening 11a the slot is somewhat smaller than the opening 11a. This arrangement allows the retainer to snap, click, or otherwise lock into place around the groove, neck or other reduction in size of the combination end pin/electrical output jack or other attachment point. The strap retaining device may be provided with an aperture 11c for the attachment of a string, cord or other flexible connector 12 so that the strap adapter and the retaining device may be connected for convenience. The outside size of the retaining device is limited only by the size of the apertures in the strap adapter, the size of the combination end pin/electrical output jack or other attaching point and by convenience. While the embodiment shown in the drawings is circular in shape, it is understood that the shape is not limited other than by convenience or aesthetic design.

In use the strap adapter is connected to the strap and then positioned over the combination end pin/electrical output jack or other attachment point. The retaining device is then engaged into the groove, neck or other reduction in size of the combination end pin/electrical output jack or other attachment point in such a way that the strap adapter is held securely on the combination end pin/electrical output jack or other attachment point between the object and the retaining device.

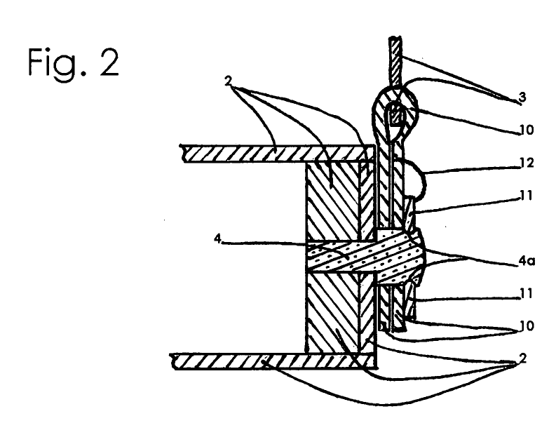

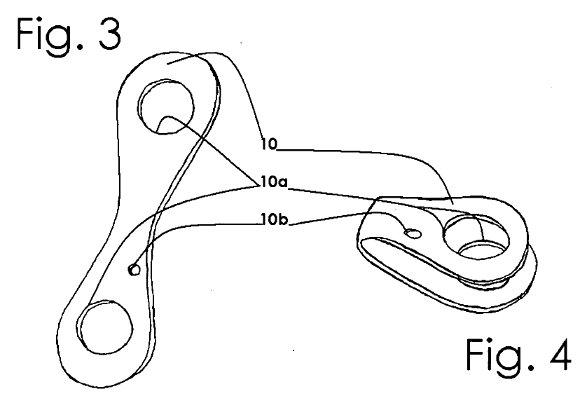

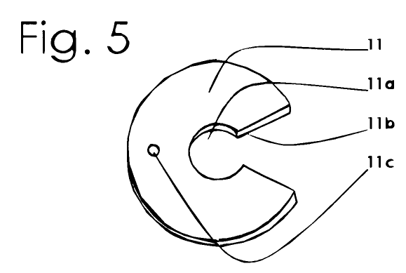

FIG. 1 and FIG. 2 show the present invention used in conjunction with a standard guitar strap 3 and a guitar 2 equipped with a combination end pin/electrical output jack 4 as is commonly found on instruments having amplifying pickups or other electric equipment. In this embodiment the strap adapter 10 is inserted through the aperture at the end of a standard guitar shoulder strap 3a (this aperture is invariably of insufficient size to fit the combination end pin/electrical output jack) and then fitted over the body of the combination end pin/electrical output jack. The strap adapter is then secured to the guitar and combination end pin/electrical output jack by sliding and locking the retaining device into the groove 4a in the combination end pin/electrical output jack thus securely retaining the strap adapter between the body of the guitar and the retaining device.

In the forgoing description and drawings the present invention is described in connection with one preferred embodiment thereof. Since many variations, modifications and applications will now be obvious to those skilled in the art, it is realized that these variations, modifications and applications may be used without departing from the scope and spirit of the present invention.

What is claimed is:

1. A strap adapter device for use with a strap with apertures(s), ring(s), loop(s) or similar opening(s) at or near the end(s). Said strap adapter device may be made to a suitable size to adapt the strap to fit a combination end pin/electrical output jack or other attaching points where the strap may be of too great or insufficient thickness, or the apertures(s), ring(s), loop(s) or similar openings of the strap are of incorrect or incompatible size to be used with the combination end pin/electrical output jack or other attaching point provided on the object to which the strap is to be attached

2. The strap adapter device in claim 1 being comprised of a thin piece of flexible, semi-flexible, semi-rigid, or rigid material. It may also be fabricated of multiple pieces of the previously mentioned materials individually or in combination. It is provided with apertures in either end, of suitable size to fit the combination end pin/electrical output jack or other attachment point on the object.

3. The method of attaching the strap adapter device in claim 1 to the strap and to the combination end pin/electrical output jack or other attachment point on the object. The strap adapter device being inserted through the aperture, ring, loop, or similar opening at or near the end of the strap with the strap adapter folded to align the apertures and said apertures then positioned over the combination end pin/electrical output jack or other attachment point on the object.

4. The method of attaching the strap adapter device in claim 1 to the strap and to the combination end pin/electrical output jack or other attachment point on the object. The strap adapter device being inserted through the aperture, ring, loop, or similar opening at or near the end of the strap with the strap adapter folded and one end of the strap adapter device inserted through the aperture in the opposite end of the strap adapter device the aperture in the free end of the strap adapter device then being positioned over the combination end pin/electrical output jack or other attachment point on the object.

5. The method of using a retaining device to secure the strap adapter device in claim 1 of the present invention to the combination end pin/electrical output jack on the object. Said combination end pin/electrical output jack having a neck, groove or other reduction in diameter into which the retaining device comprising a flat plate of flexible, semi-flexible, or semi-rigid material with an internal opening sized to be compatible with the neck, groove, or other reduction in diameter of the combination end pin/electrical output jack on the object. Said retaining device includes a tapered slot sized such that the slot where it meets the internal opening in the retaining device is somewhat narrower than the internal opening with said slot tapering outward to a convenient size to engage the combination end pin/electrical output jack on the object. This retaining device to be made of a suitable thickness and size with openings of suitable size to engage and lock into the combination end pin/electrical output jack on the object and secure a properly fitting strap or the strap adapter device of the current invention between the object and the retaining device.

6. The use of the present invention to secure a strap to a guitar or similar musical instrument, especially, but not limited to a guitar equipped with a commercially available combination end pin/electrical output jack type of end pin strap attachment as is common on instruments equipped with various amplification pickup devices.
